(19) United States
(12) Patent Application Publication
(10) Pub. No.: US 2017/0321964 A1
(43) Pub. Date: Nov. 9, 2017

(54) HIGH TEMPERATURE CERAMIC SUPPORT RACK

(71) Applicant: SAINT-GOBAIN CERAMICS & PLASTICS, INC., Worcester, MA (US)

(72) Inventors: John BEVILACQUA, Williamsville, NY (US); Lawrence M. BANACH, Lockport, NY (US)

(21) Appl. No.: 15/586,054

(22) Filed: May 3, 2017

Related U.S. Application Data
(60) Provisional application No. 62/331,029, filed on May 3, 2016.

(51) Int. Cl. F27D 5/00; C04B 35/64; B65G 49/08

(52) U.S. Cl. CPC F27D 5/0006; B65G 49/085; C04B 35/64

(57) ABSTRACT

A support rack can include a first component comprising a ceramic material and a second component comprising a ceramic material. The first component can intersect at least one wall of the second component and the first and second components can be coupled via a ceramic weld. A method of making a support rack can include providing a first component comprising a sintered ceramic material, providing a second component comprising an un-sintered or partially-sintered ceramic material, arranging the first and second component so that the first component intersects at least one wall of the second component, sinter bonding the first and second components together to form a ceramic weld at the intersection. In an embodiment, the support rack can be a piece of kiln furniture.

### CROSS-REFERENCE TO RELATED APPLICATION(S)

This application claims priority under 35 U.S.C. §119(e) to U.S. Patent Application No. 62/331,029, filed on May 3, 2016, entitled “HIGH TEMPERATURE CERAMIC SUPPORT RACK,” by John Bevilacqua et al., which is assigned to the current assignee hereof and is incorporated herein by reference in its entirety.

### FIELD OF THE DISCLOSURE

The present disclosure relates to a ceramic support rack and methods of making a ceramic support rack.

### BACKGROUND

Certain ceramic bodies can be utilized as a support within a thermally insulated chamber. However, these ceramic bodies can deform or crack under loads at extreme temperatures. There exists a need for improved ceramic bodies.

### BRIEF DESCRIPTION OF THE DRAWINGS

Embodiments are illustrated by way of example and are not limited in the accompanying figures.

FIG. 1 includes a perspective-view illustration of an embodiment of the high temperature support rack described herein.

FIG. 2 includes a top-view illustration of an embodiment of the high temperature support rack described herein.

FIG. 3 includes a side-view illustration of an embodiment of the high temperature support rack described herein.

FIG. 4 includes another side-view illustration of an embodiment of the high temperature support rack described herein.

FIG. 5 includes a plot of film coefficient versus temperature difference of a conventional sample and a support rack in accordance with an embodiment.

FIG. 6 includes a plot of thermal stress versus temperature difference of a conventional sample and a support rack in accordance with an embodiment.

FIG. 7 includes a plot of film coefficient versus thermal stress of a conventional sample and a support rack in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the ceramic arts.

The ceramic body described herein can be used as a rack, shelf, setter, and the like, in high temperature, extreme environment settings. Existing kiln furniture has limited capabilities in part because the weight of large body monoliths can cause deformation under extreme temperatures, such as temperatures in excess of 1200° C.

An advantage of the high temperature support rack described herein is that, in an embodiment, the high temperature support rack can maintain its shape at temperatures greater than 1200° C., or greater than 1300° C., or greater than 1400° C., or even greater than 1500° C. The high temperature support rack can be manufactured using sintered ceramic rods assembled with green ceramic rods. As will be described in more detail below, these components can be arranged in a precise pattern and sinter bonded to become a stable, strong, latticed, monolithic material capable of withstanding the extreme temperatures mentioned above.

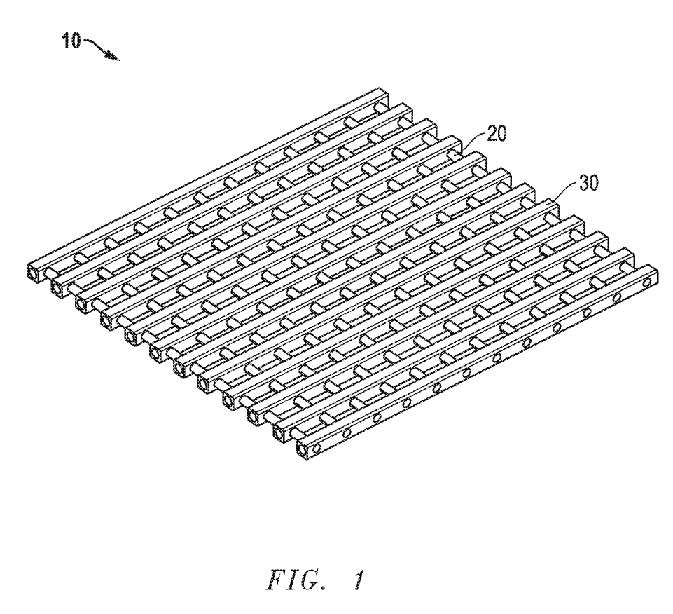

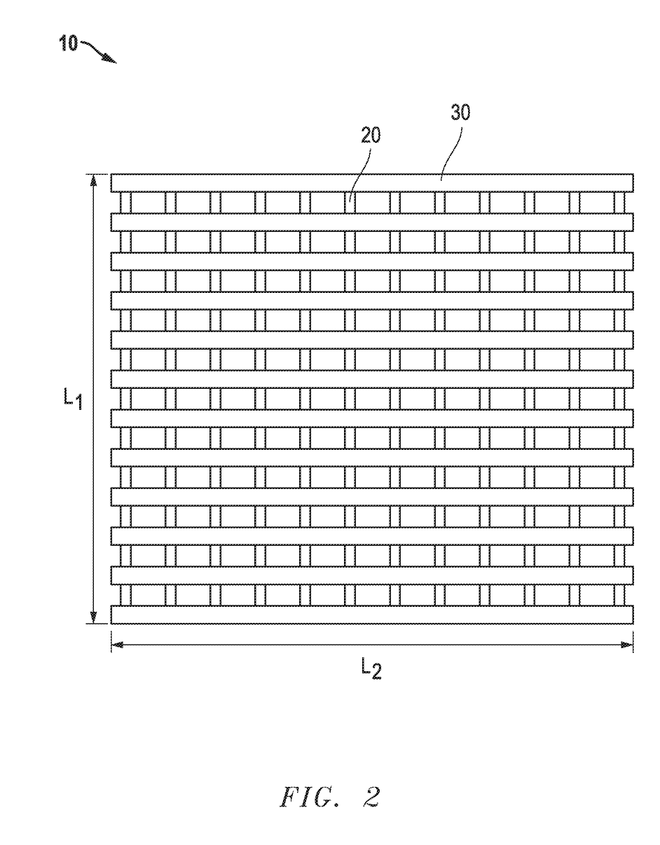

In an embodiment, as illustrated in FIGS. 1 and 2, the high temperature support rack 10 includes a plurality of first ceramic rods 20 intersected with a plurality of second ceramic rods 30. The first and second ceramic rods 20,30 can be coupled at the intersection via a ceramic weld. As used herein, the term “ceramic weld” refers to a weld formed between two ceramic materials via sinter bonding.

According to an aspect, the ceramic material of at least one of the first rods 20 and second ceramic rods 30 can include silicon carbide. In a particular embodiment, the ceramic material of each of the first ceramic rods 20 or second ceramic rods 30. In another embodiment, at least one of the first ceramic rods 20 and the second ceramic rods can include the same ceramic material. In another particular embodiment, each of the first ceramic rods 20 and the second ceramic rods 30 can include the same ceramic material, such as silicon carbide. In a further embodiment, the silicon carbide can include sintered silicon carbide, reaction bonded silicon carbide, recrystallized silicon carbide, or a combination thereof. In still a further embodiment, the silicon carbide can include alpha silicon carbide or beta silicon carbide. In a particular illustrative embodiment, the first ceramic rods 20 can include at least 90 wt. % of silicon carbide, such as at least 92 wt. % or at least 95 wt. % of silicon carbide for the total weight of the first ceramic rods 20. In a particular illustrative embodiment, the second ceramic rods 30 can include at least 90 wt. % of silicon carbide, such as at least 92 wt. % or at least 95 wt. % of silicon carbide for the total weight of the second ceramic rods. In a particular embodiment, each of the first and second ceramic rods can consist essentially of silicon carbide. The first ceramic rods 20, the second ceramic rods 30, or both may include a total content of impurities of not greater than 5 wt. % for the total weight of the respective rods, such as not greater than 3 wt. % or even not greater than 1 wt. % impurities. In a more particular embodiment, the first and second ceramic rods 20,30 can consist essentially of alpha silicon carbide.

The first ceramic rods 20 and the second ceramic rods 30 can intersect in a variety of patterns depending on the desired application. In an embodiment, first ceramic rods are orthogonal to the second ceramic rods. In a particular embodiment, as illustrated in FIGS. 1 and 2, the high temperature support rack 10 can include a plurality of first ceramic rods 20 and a plurality of second ceramic rods 30, and the first and second ceramic rods 20,30 intersect orthogonally in a lattice configuration.

Each of the first ceramic rods can include an outer surface and a filled center or a sidewall defining an outer surface and a hollow center. For example, a first ceramic rod with a hollow center can be a ceramic tube. In an embodiment, the first ceramic rod has a hollow center to reduce weight. The shape of the first ceramic rods 20 can depend on the desired application. In an embodiment, as illustrated in FIGS. 1 and 2, the first ceramic rods 20 have a cylindrical shape with a circular profile.

Further, the sidewall of the first ceramic rods 20 can be continuous, without any apertures. For example, the first ceramic rods 20 can have a smooth outer surface from one end to the other. Of course, as discussed above, when the first ceramic rods are assembled with the second ceramic rods 30 to form the high temperature support rack 10, there can be a ceramic weld formed at the intersection of the first and second ceramic rods 20,30. Thus, the outer surface of the first ceramic rods 20 after assembly will no longer have the smooth outer surface at the intersections. However, in an embodiment, at least the exposed portion of the first ceramic rods 20, such as between intersections can have a smooth outer surface.

As illustrated in FIG. 3, the first ceramic rods 20 can include at least one first ceramic rod 20 having a width or diameter W₁ of at least 0.3 cm, or at least 0.5 cm, or at least 0.7 cm. Further, at least one first ceramic rod 20 can have a width or diameter of at most 11 cm, or at most 9 cm, or at most 7 cm. Furthermore, at least one first ceramic rod 20 can have a width or diameter W₁ in a range of any of the above minimum and maximum values, such as in a range of 0.3 to 11 cm, or 0.5 to 9 cm, or 0.7 to 7 cm. In an embodiment, each of the first ceramic rods 20 has the same width or diameter W₁, or essentially the same width or diameter W₁. Each of the first ceramic rods 20 can have a width or diameter W₁ within the values described above. In addition, it is possible that one or more of the first ceramic rods 20 could have a width or diameter W₁ greater than or less than the values described above. Thus, the width or diameter W₁ described herein should only be considered as particular embodiments and not to limit the disclosure to any particular width or diameter W₁.

As illustrated in FIG. 2, the first ceramic rods 20 can include at least one first ceramic rod 20 having a length L₁ of at least 40 cm, or at least 50 cm, or at least 60 cm, or at least 70 cm, or at least 80 cm, or at least 90 cm. Further, at least one first ceramic rod 20 can have a length L₁ of at most 150 cm, or at most 130 cm, or at most 110 cm. Furthermore, at least one first ceramic rod 20 can have a length L₁ in a range of any of the above minimum and maximum values, such as in a range of 40 to 150 cm, or 60 to 130 cm, or 90 to 110 cm. In addition, it is possible that one or more of the first ceramic rods 20 could have a length L₁ greater than or less than the values described above. Thus, the length L₁ described herein should only be considered as particular embodiments and not to limit the disclosure to any particular length L₁.

In an embodiment, each of the first ceramic rods has the same length L₁, or essentially the same length L₁. Each of the first ceramic rods 20 can have a length L₁ within the values described above. In addition, it is possible that one or more of the first ceramic rods 20 could have a length L₁ greater than or less than the values described above. In the assembled high temperature support rack, the length L₁ of the first ceramic rods 20 can be measured from one end of the support rack to the other end of the support rack, starting and stopping at the opposite ends of a first ceramic rod 20.

Prior to assembly with the second ceramic rods 30, the first ceramic rods 20 can be fully sintered ceramic rods. That is, the first ceramic rods 20 can undergo full sintering prior to intersecting with the second ceramic rods 30.

As with the first ceramic rods 20, the second ceramic rods 30 can include an outer surface with a filled center or a sidewall defining an outer surface and a hollow center. For example, a second ceramic rod with a hollow center can be a ceramic tube. The shape of the second ceramic rods 30 can depend on the desired application. In an embodiment, as illustrated in FIGS. 1 and 2, the second ceramic rods 30 can have a polyhedral shape with a polygonal outer profile. While the inner profile can have the same shape as the outer profile, in an embodiment, the inner profile has a circular inner profile. As used herein, the term “outer profile” refers to the shape of the outer perimeter of a cross-section of the sidewall and the term “inner profile” refers to the shape of the inner perimeter of a cross-section of the sidewall. In a particular embodiment, the polyhedral shape can be a rectangular cuboid. In a more particular embodiment, the rectangular cuboid can have arcuate corners along the length of the second ceramic rods 30.

Further, at least one portion or side of the sidewall of the second ceramic rods 30 can be continuous, without any apertures. For example, at least one portion or side of the sidewall of the second ceramic rods 30 can have a smooth outer surface from one end to the other. Of course, as discussed above, when the first ceramic rods 20 are assembled with the second ceramic rods 30 to form the high temperature support rack, there can be a ceramic weld formed at the intersection of the first and second ceramic rods 20,30. Thus, the outer surface of the sidewall of the second ceramic rods 30 after assembly will not have the smooth outer surface at the intersections. Thus, at least one portion or side of the sidewall of the second ceramic rods 30 can have a discontinuous surface, such as a surface interrupted by intersections with the first ceramic rods 20. However, in an embodiment, at least the exposed portion of the second ceramic rods 30 without or between the intersections can have a smooth outer surface.

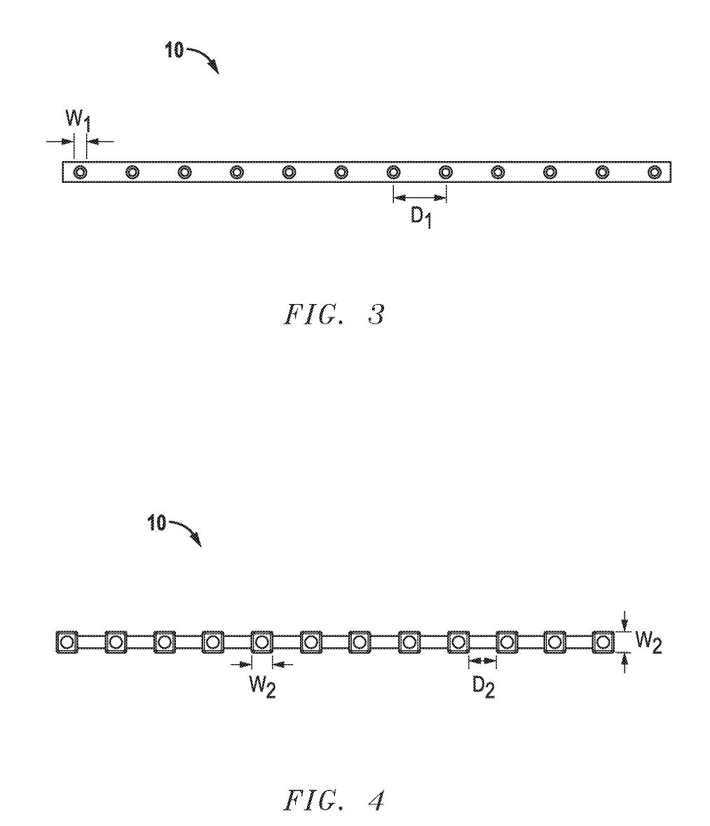

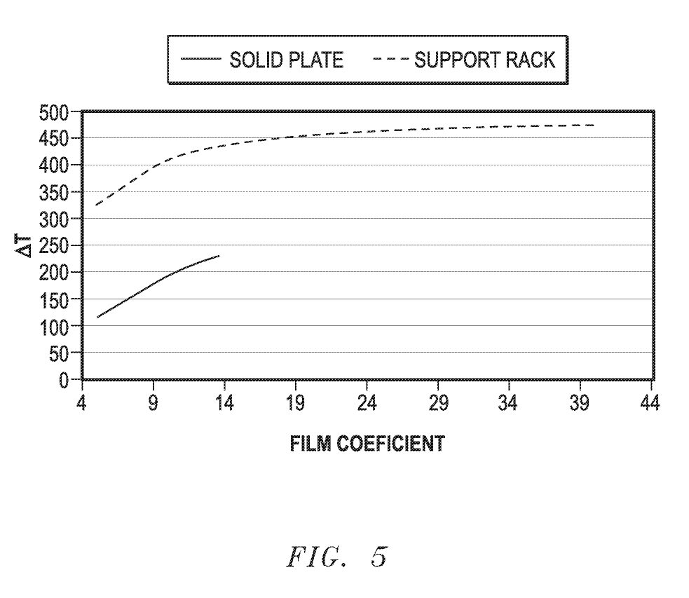

As illustrated in FIG. 4, the second ceramic rods 30 can include at least one second ceramic rod 30 having a width or diameter W₂ of at least 0.8 cm, or at least 1 cm, or at least 1.2 cm. Further, at least one second ceramic rod 30 can have a width or diameter W₂ of at most 11.1 cm, or at most 9.1 cm, or at most 7.1 cm. Furthermore, at least one second ceramic rod 30 can have a width or diameter W₂ in a range of any of the above minimum and maximum values, such as in a range of 0.8 to 11.1 cm, or 1 to 9.1 cm, or 1.2 to 7.1 cm. In an embodiment, each of the second ceramic rods 30 has the same width or diameter W₂, or essentially the same width or diameter W₂. Each of the second ceramic rods 30 can have a width or diameter within the values described above. In addition, it is possible that one or more of the second ceramic rods 30 could have a width or diameter W₂ greater than or less than the values described above. Thus, the widths or diameter W₂ described herein should only be considered as particular embodiments and not to limit the disclosure to any particular width or diameter W₂.

In an embodiment, the width or diameter W₂ of the second ceramic rods 30 is greater than the width or diameter W₁ of the first ceramic rods 20. As will be discussed in more detail below, the method of making the high temperature support rack 10 can include inserting the first ceramic rod 20 through the thickness of the second ceramic rod 30 via apertures in the second ceramic rod 30. Thus, in such an embodiment, the second ceramic rods 30 would have a width or diameter W₂ greater than the width or diameter of the first ceramic rods 20 so as to support an aperture sufficient to encompass the first ceramic rod 20.

As illustrated in FIG. 2, the second ceramic rods 30 can include at least one second ceramic rod having a length L₂ of at least 50 cm, or at least 60 cm, or at least 70 cm, or at least 80 cm, or at least 90 cm, or at least 100. Further, at least one second ceramic rod 30 can have a length L₂ of at most 160 cm, or at most 150 cm, or at most 140 cm. Furthermore, at least one second ceramic rod 30 can have a length L₂ in a range of any of the above minimum and maximum values, such as in a range of 60 to 160 cm, or 80 to 150 cm, or 100 to 140 cm. In addition, it is possible that one or more of the second ceramic rods 30 could have a length L₂ greater than or less than the values described above. Thus, the length L₂ described herein should only be considered as particular embodiments and not to limit the disclosure to any particular length L₂.

In an embodiment, each of the second ceramic rods 30 has the same length L₂, or essentially the same length L₂. Each of the second ceramic rods 30 can have a length within the values described above. In addition, it is possible that one or more of the second ceramic rods 30 could have a length L₂ greater than or less than the values described above. In the assembled high temperature support rack, the length L₂ of the second ceramic rods 30 can be measured from one end of the support rack to the other end of the high temperature support rack 10, starting and stopping at the opposite ends of a second ceramic rod 30.

Prior to assembly with the first ceramic rods 20, the second ceramic rods 30 can each include a plurality of apertures spaced apart a distance D₁, measured from a center of one aperture to the center of the next closest aperture. In an embodiment, the distance D₁ is at least 0.1 cm, or at least 0.5 cm, or at least 1 cm, or at least 3 cm, or at least 5 cm, or at least 7 cm. In another embodiment, the distance D₁ is at most 30 cm, or at most 25 cm, or at most 20 cm, or at most 16 cm, or at most 12 cm. The distance D₁ can be in a range of any of the above minimum and maximum values, such as in a range of 0.1 to 30 cm, or 0.5 to 25 cm, or 1 to 20 cm, or 3 to 16 cm, or 5 to 12 cm. In addition, it is possible that the distance D₁ can be greater than or less than the values described above. Thus, the distances D₁ described herein should only be considered as particular embodiments and not to limit the disclosure to any particular distances D₁.

Further, the apertures of the second ceramic rods 30 can have a width or diameter W₂ (see FIG. 4) that is equal to the width or diameter W₁ (see FIG. 3) of the first ceramic rods 20. Further, prior to assembly with the first ceramic rods 20, the second ceramic rods 30 can be green ceramic rods. As used herein, the term “green ceramic rod” refers to a ceramic rod formed of a weakly bonded ceramic material that has not yet been sintered or has only been partially sintered. Furthermore, prior to assembly, the second ceramic rods 30 can include a plurality of green ceramic rods each having the same dimensions, or essentially the same dimensions.

The plurality of green ceramic rods can have the same, or essentially the same, number of apertures and distance between apertures, such that, when laid side-by-side the apertures can form a continuous channel However, prior to assembly, the apertures in the green ceramic rods can have a width or diameter that is greater than the width or diameter of the first ceramic rods. In an embodiment, during sintering, the apertures of the green ceramic rods shrink to surround an outer surface of a portion of the first component and form a ceramic weld at the intersection.

The high temperature support rack 10 can be assembled according to a method including providing a plurality of first ceramic rods that are fully sintered and a plurality of second ceramic rods that are green ceramic rods, arranging the first and second ceramic rods in a predetermined configuration to form a support rack precursor, and sinter bonding the predetermined configuration to form a monolithic high temperature support rack 10.

Arranging the first and second ceramic rods 20,30 in a predetermined configuration can include arranging a plurality of second ceramic rods comprising green ceramic rods having a plurality of apertures, as described above, in a side by side configuration, spaced apart a distance D₂, as illustrated in FIG. 4. The distance D₂ between second ceramic rods 30 can be at least 0.1 cm, or at least 0.5 cm, or at least 1 cm, or at least 3 cm, or at least 5 cm. The distance D₂ between second ceramic rods 30 can be at most 20 cm or at most 15 cm, or at most 10 cm, or at most 8 cm, or at most 6 cm. Moreover, the distance D₂ between second ceramic rods 30 can be in a range of any of the above minimum and maximum values, such as in a range of 0.1 to 20 cm, or 0.5 to 15 cm, or 1 to 10 cm, or 3 to 8 cm, or 5 to 6 cm. In addition, it is possible that the distance D₂ can be greater than or less than the values described above. Thus, the distances D₂ described herein should only be considered as particular embodiments and not to limit the disclosure to any particular distances D₂.

The first ceramic rods 20 can include a plurality of first ceramic rods 20 and, when the second ceramic rods 30 are arranged in the side-by-side configuration, each of the plurality of first ceramic rods 20 can be inserted into the channel created by the apertures of the second ceramic rods 30, forming the predetermined configuration, such as the lattice configuration illustrated in FIGS. 1 and 2. In such a lattice configuration, the first and second ceramic rods 20,30 can be arranged such that the sintered rods intersect orthogonally with the green ceramic rods.

When in the predetermined configuration, the sintered first ceramic rods 20 and the green second ceramic rods 30 can be sintered together, forming a ceramic weld at the intersections. The sinter bonding between the first ceramic rods 20 and the second ceramic rods 30 can occur via the method disclosed in U.S. Pat. No. 8,998,268 to Banach et al., which is incorporated herein by reference in its entirety. In an embodiment, during sintering, the apertures of the green ceramic rods shrink to surround an outer surface of a portion of the first component and form a ceramic weld at the intersection interface.

The high temperature support rack 10 can have an overall length having the length of the longer of the first or second ceramic rods 20,30. Further, the high temperature support rack can have an overall width of the shorter of the length of the first or second ceramic rods 20,30. In an embodiment, the high temperature support rack can have a total area of at least 2000 cm², or at least 4000 cm², or at least 6000 cm², or at least 8000 cm². In an embodiment, the high temperature support rack can have a total area of at most 12000 cm², or at most 11000 cm², or at most 10000 cm². In an embodiment, the high temperature support rack can have a total area in a range of any of the above minimum and maximum values, such as in a range of 2000 to 12000 cm², or 4000 to 11000 cm², or 6000 cm² to 10000 cm². That being said, the high temperature support rack described herein can be made to have a size and shape that fits a desired application. Applicants have discovered particular advantages of embodiments of the high temperature support rack having the particular sizes described herein. However, even in smaller sizes or larger sizes, the high temperature support rack can provide a lightweight, durable rack as compared to a monolithic slab of the same size. Thus, the sizes described herein should only be considered as particular embodiments and not to limit the disclosure to any particular size.

In an embodiment, the high temperature support rack comprises the first and second rods 20,30 in a lattice configuration that defines a plurality of open windows at least one having an area of at least 2 cm², at least 3 cm², at least 4 cm², at least 5 cm², at least 6 cm². The open windows can have an area of at most 100 cm², or at most 50 cm², or at most 20 cm², or at most 15 cm², or at most 10 cm². The open windows can have an area in a range of any of the above minimum and maximum values, such as in a range of 2 to 100 cm², or 2 to 50 cm², or 2 to 20 cm², or 4 to 15 cm², or 6 to 10 cm². In addition, it is possible that the area of the open windows can be greater than or less than the values described above. Thus, the sizes described herein should only be considered as particular embodiments and not to limit the disclosure to any particular size.

An advantage of the high temperature support rack 10 is the ability to withstand a temperature of at least 1000° C., at least 1200° C., at least 1400° C., or at least 1600° C., while maintaining its structural integrity. For example, the second ceramic rods 30 can have a surface variation after sintering of no greater than 0.4 cm, or no greater than 0.3 cm, or even no greater than 0.2 cm. Further, the second ceramic rods can maintain or minimally increase their low surface variation after at least one cycle at extreme temperatures, such as no greater than 0.5 cm, or no greater than 0.3 cm, or no greater than 0.1 cm increase in surface variation at 22° C. after at least one cycle to a temperature of at least 1000° C., at least 1200° C., at least 1400° C., or at least 1600° C. A cycle, as used herein with respect to surface variation, refers to heating from 22° C. to a given temperature and back to 22° C. over a period of at least 30 minutes. The surface variation is measured after sintering the high temperature support rack (with or without additional machining, depending on the desired measurement). A precision granite surface plate large enough to accommodate the complete size of the rack is provided. Three precision raised contact pillars of the same height are placed on the surface plate to establish a surface plane. For example, for a square rack, the rack is placed on the pillars such that two pillars are contacting adjacent corners and the third pillar is contacting a central point between the other two corners. The pillars are sized sufficient to accommodate a dial indicator between the rack and the surface plate. The dial indicator is mounted to a movable base and placed under the rack so that the indicator point is touching the surface of the second rod. The indicator is moved about the entire surface of each of the second rods and the highest and lowest indicator readings are recorded. The lowest overall indicator reading is subtracted from the highest overall indicator reading to arrive at the surface variation.

In some applications, grinding can be performed on at least one major surface of the sintered high temperature support rack to obtain a certain surface variation or surface flatness. The terms, surface flatness and surface variation, can be used interchangeably in this disclosure. In an embodiment, a horizontal surface grinder having a size that can accommodate the high temperature support rack may be used. The high temperature support rack can be shimmed on the worktable and ground with a grinding wheel to remove unevenness and obtain a desired surface flatness. The grinding wheel can have diamond abrasive grains, cubic boron nitride grains, or other types of grains having similar hardness as diamond. In a particular application, a diamond grinding wheel can be used. The diamond grains can have a grit size of 40, 60, 80, 100, 120, 200, 270, 325, or up to 600 and be present in the grinding wheel in a concentration of up to 125. The grinding wheel can have a resin bond or a metal bond material. The surface flatness can be measured in the same manner as surface variation as disclosed herein.

In an embodiment, at least one of the major surfaces of the high temperature support rack can have a certain surface flatness, such as at most 50 μm or at most 47 μm or at most 40 μm or at most 35 μm or at most 30 μm or at most 26 μm or at most 25 μm. In another embodiment, the surface flatness can be at least 2 μm or at least 5 μm or at least 8 μm or at least 10 μm or at least 14 μm or at least 18 μm or at least 20 μm. Moreover, the high temperature support rack can have a surface flatness within a range including any of the minimum and maximum values noted herein. For instance, the surface flatness can be within a range of 2 μm to 50 μm. In a particular illustrative embodiment, the surface flatness of the high temperature support rack can be within a range of 10 μm to 30 μm.

In an embodiment, the high temperature support rack 10 can be utilized as an article of kiln furniture. The kiln furniture can include a rack, a shelf, a setter, and the like, and can be utilized in high temperature, extreme environment settings.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

### Embodiment 1

A high temperature support rack comprising:
a plurality of first ceramic rods comprising a ceramic material; and
a plurality of second ceramic rods comprising a ceramic material;
wherein the first ceramic rods intersect with the second ceramic rods and the first and second ceramic rods are coupled via a ceramic weld.

### Embodiment 2

A method of making a high temperature support rack comprising:
providing a plurality of first ceramic rods comprising a sintered ceramic material;
providing a plurality of second ceramic rods comprising a green ceramic material;
arranging the first and second ceramic rods so that the sintered first ceramic rods intersect with the green second ceramic rods; and
sinter bonding the first and second ceramic rods together to form a ceramic weld at the intersection.

### Embodiment 3

The method of embodiment 2, wherein the green second ceramic rods each comprise at least one aperture corresponding to each of the first ceramic rods.

### Embodiment 4

The method of embodiment 3, wherein arranging the first and second ceramic rods comprises arranging the plurality of green second ceramic rods to align the corresponding apertures and extending the first ceramic rods through the corresponding apertures of the green second ceramic rods so as to form a lattice structure.

### Embodiment 5

The method of any one of embodiments 3 and 4, wherein, during sintering, the apertures of the second ceramic rods shrink to surround an outer surface of a portion of each of the first ceramic rods.

### Embodiment 6

The method of embodiment 5, wherein the ceramic material of the green second ceramic rod has a differential shrinkage sufficient to ensure bonding during the sinter bonding.

### Embodiment 7

The support rack or method of any one of the preceding embodiments, wherein at least one of the first ceramic rods comprises a sidewall defining an outer surface and an inner hollow center.

### Embodiment 8

The support rack or method of any one of the preceding embodiments, wherein at least one of the first ceramic rods has a cylindrical shape.

### Embodiment 9

The support rack or method of any one of the preceding embodiments, wherein at least one of the first ceramic rods has a width or diameter of at least 0.3 cm, or at least 0.5 cm, or at least 0.7 cm.

### Embodiment 10

The support rack or method of any one of the preceding embodiments, wherein at least one of the first ceramic rods has a width or diameter of at most 11 cm, or at most 9 cm, or at most 7 cm.

### Embodiment 11

The support rack or method of any one of the preceding embodiments, wherein at least one of the first ceramic rods has a width or diameter in a range of 0.3 to 11 cm, or 0.5 to 9 cm, or 0.7 to 7 cm.

### Embodiment 12

The support rack or method of any one of the preceding embodiments, wherein a width or diameter of at least one of the second ceramic rods is greater than a width or diameter of at least one of the first ceramic rods.

### Embodiment 13

The support rack or method of any one of the preceding embodiments, wherein at least one of the first ceramic rods has a length of at least 40 cm, or at least 50 cm, or at least 60 cm, or at least 70 cm, or at least 80 cm, or at least 90 cm.

### Embodiment 14

The support rack or method of any one of the preceding embodiments, wherein at least one of the first ceramic rods has a length of at most 150 cm, or at most 130 cm, or at most 110 cm.

### Embodiment 15

The support rack or method of any one of the preceding embodiments, wherein at least one of the first ceramic rods has a length in a range of 40 to 150 cm, or 60 to 130 cm, or 90 to 110 cm.

### Embodiment 16

The support rack or method of any one of the preceding embodiments, wherein the ceramic material of at least one of the first ceramic rods comprises silicon carbide.

### Embodiment 17

The support rack or method of any one of the preceding embodiments, wherein the ceramic material of at least one of the second ceramic rods comprises silicon carbide.

### Embodiment 18

The support rack or method of any one of the preceding embodiments, wherein the ceramic material of at least one of the first ceramic rods is the same as the ceramic material of at least one of the second ceramic rods.

### Embodiment 19

The support rack or method of any one of the preceding embodiments, wherein at least one of the first ceramic rods comprises a sidewall defining an outer surface and an inner hollow center.

### Embodiment 20

The support rack or method of any one of the preceding embodiments, wherein at least one of the second ceramic rods has an outer surface having a shape of a polyhedron.

### Embodiment 21

The support rack or method of embodiment 20, wherein the polyhedron includes a cuboid.

### Embodiment 22

The support rack or method of embodiment 21, wherein the cuboid is a rectangular cuboid with rounded corners along a length of the rod.

### Embodiment 23

The support rack or method of any one of the preceding embodiments, wherein at least one of the second ceramic rods has a width or diameter of at least 0.8 cm, or at least 1 cm, or at least 1.2 cm.

### Embodiment 24

The support rack or method of any one of the preceding embodiments, wherein at least one of the second ceramic rods has a width or diameter of at most 11.1 cm, or at most 9.1 cm, or at most 7.1 cm.

### Embodiment 25

The support rack or method of any one of the preceding embodiments, wherein at least one of the second ceramic rods has a width or diameter in a range of 0.8 to 11.1 cm, or 1 to 9.1 cm, or 1.2 to 7.1 cm.

### Embodiment 26

The support rack or method of any one of the preceding embodiments, wherein at least one of the second ceramic rods has a length of at least 50 cm, or at least 60 cm, or at least 70 cm, or at least 80 cm, or at least 90 cm, or at least 100.

### Embodiment 27

The support rack or method of any one of the preceding embodiments, wherein at least one of the second ceramic rods has a length of at most 160 cm, or at most 150 cm, or at most 140 cm.

### Embodiment 28

The support rack or method of any one of the preceding embodiments, wherein at least one of the second ceramic rods has a length in a range of 60 to 160 cm, or 80 to 150 cm, or 100 to 140 cm.

### Embodiment 29

The support rack or method of any one of the preceding embodiments, wherein the plurality of first ceramic rods are orthogonal to the plurality of second ceramic rods.

### Embodiment 30

The support rack or method of any one of the preceding embodiments, wherein the first and second ceramic rods intersect in a lattice configuration.

### Embodiment 31

The support rack or method of any one of the preceding embodiments, wherein the support rack has a length of at least 50 cm, or at least 60 cm, or at least 70 cm, or at least 80 cm, or at least 90 cm, or at least 100 cm.

### Embodiment 32

The support rack or method of any one of the preceding embodiments, wherein the support rack has a width of at least 40 cm, or at least 50 cm, or at least 60 cm, or at least 70 cm, or at least 80 cm, or at least 90 cm.

### Embodiment 33

The support rack or method of any one of the preceding embodiments, wherein the support rack has a total area of at least 2000 cm², at least 4000 cm², at least 6000 cm², or at least 8000 cm².

### Embodiment 34

The support rack or method of any one of the preceding embodiments, wherein the support rack has a total area of at most 12000 cm², or at most 11000 cm², or at most 10000 cm².

### Embodiment 35

The support rack or method of any one of the preceding embodiments, wherein the support rack has a total area in a range of 2000 to 12000 cm2, or 4000 to 11000 cm², or 6000 cm² to 10000 cm².

### Embodiment 36

The support rack or method of any one of the preceding embodiments, wherein the support rack comprises the first and second ceramic rods in a lattice configuration that defines a plurality of open windows at least one having an area of at least 2 cm², at least 3 cm², at least 4 cm², at least 5 cm², at least 6 cm².

### Embodiment 37

The support rack or method of any one of the preceding embodiments, wherein the support rack comprises the first and second ceramic rods in a lattice configuration that defines a plurality of open windows at most 100 cm², at most 50 cm², or at most 20 cm², or at most 15 cm², or at most 10 cm².

### Embodiment 38

The support rack or method of any one of the preceding embodiments, wherein the support rack comprises the first and second ceramic rods in a lattice configuration that defines a plurality of open windows at least one having an area in a range of 2 to 100 cm², or 2 to 50 cm², or 2 to 20 cm², or 4 to 15 cm², or 6 to 10 cm².

### Embodiment 39

The support rack or method of any one of the preceding embodiments, wherein the support rack has a surface variation at 22° C. of at most 0.5 cm after heating to a temperature of at least 1000° C., at least 1200° C., at least 1400° C., or at least 1600° C.

### Embodiment 40

The support rack or method of any one of the preceding embodiments, wherein the outermost surface of the support rack is defined by the second component and the outermost surface has a surface variation at 22° C. of no greater than 0.4 cm, no greater than 0.3 cm, or even no greater than 0.2 cm.

### Embodiment 41

An article of kiln furniture comprising the support rack of any one of the preceding embodiments.

### Embodiment 42

The support rack or method of any one of the preceding embodiments, wherein the support rack has a surface flatness of at most 100 μm.

### EXAMPLE

A high temperature support rack was formed in accordance with embodiments herein using a ceramic material of Hexoloy® SE (commercially available from Saint-Gobain Ceramics & Plastics, Inc.). A solid plate was formed using a similar ceramic material, Hexoloy® SA (commercially available from Saint-Gobain Ceramics & Plastics, Inc.). The samples had the same dimension of 36″×41″×1.25″. The solid plate weighed 215 pounds, and the high temperature rack weighed 62 pounds, 72% less than the solid plate.

The solid plate and high temperature support rack samples were tested in the same simulating conditions using a simulation software, Ansys FEA 14.5 (commercially available from Ansys). A cordierite drum of Ø20×6″ was used to support the center of each sample. The entire bodies of the samples were exposed to an initial temperature of 500° C. and then a convection. Convection employs both temperature and film coefficient. In this test, the convection temperature was kept at an ambient temperature (about 25° C.), and a series of film coefficients were applied to each sample. The temperature of the portion of the sample under the center of the thermal mass was used as the maximum temperature, and the temperature of the corner that was furthest away from the center of the thermal mass was used as the minimum temperature for each applied film coefficient.

The starting film coefficient was 5 W/msqC, which simulated a standard ambient condition that a heated sample is left in air to cool down without any external force. Then the film coefficient was increased to simulate forced convection which is defined as convection in which the movement of fluid (e.g., air) does not happen naturally but is helped by a device such as a fan or pump. Forced convection was used to simulate normal and extreme thermal conditions (e.g., aggressive cooling cycles). Thermal stress generated within the samples by each convection was computed by the software based on the equation.

TABLE 1

| | Maximum | Minimum | | | |
|---|---|---|---|---|---|
| Film | Tem- | Tem- | | Thermal | Derivation |
| Coefficient | perature | perature | | Stress | of Film |
| (W/msqC) | (° C.) | (° C.) | ΔT | (Mpa) | Coefficient |
| 5 | 500 | 381.28 | 118.72 | 190.06 | 7.23 |
| 10 | 500 | 306.93 | 193.07 | 228.05 | 12.06 |
| 12.5 | 500 | 279.31 | 220.69 | 268.52 | 12.80 |
| 12.8 | 500 | 276.33 | 223.67 | 273.01 | 12.89 |
| 12.9 | 500 | 275.35 | 224.65 | 274.49 | 12.92 |
| 13.5 | 500 | 269.6 | 230.4 | 283.22 | 13.11 |

TABLE 2

| | Maximum | Minimum | | | |
|---|---|---|---|---|---|
| Film | Tem- | Tem- | | Thermal | Derivation |
| Coefficient | perature | perature | | Stress | of Film |
| (W/msqC) | (° C.) | (° C.) | ΔT | (Mpa) | Coefficient |
| 5 | 500 | 173.99 | 326.01 | 78.174 | 11.61 |
| 10 | 500 | 91.813 | 408.187 | 109.24 | 25.17 |
| 15 | 500 | 60.126 | 439.874 | 127.81 | 32.27 |
| 20 | 500 | 45.289 | 454.711 | 141.07 | 38.99 |
| 25 | 500 | 37.489 | 462.511 | 163.52 | 42.04 |
| 30 | 500 | 33.055 | 466.945 | 171.62 | 48.07 |
| 40 | 500 | 27.6013 | 472.3987 | 189.74 | 57.97 |

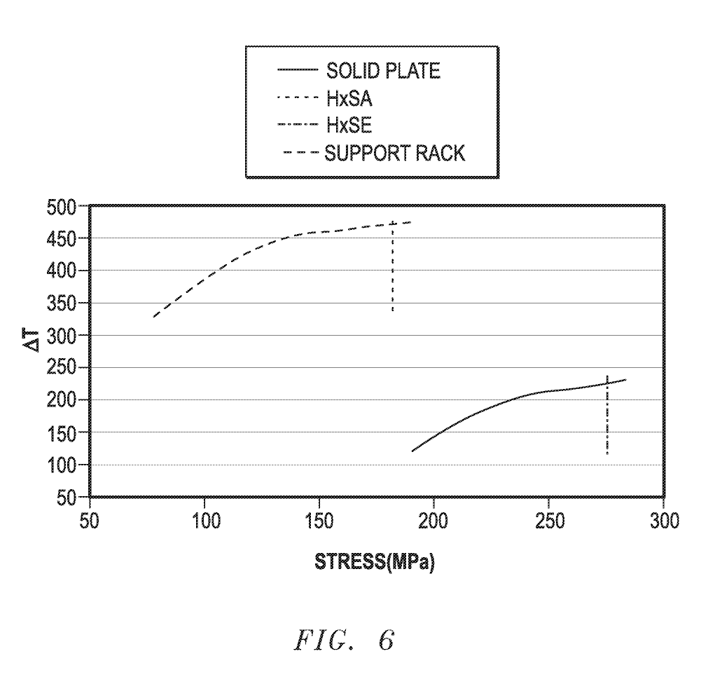

FIG. 5 includes a plot of film coefficients versus temperature differences of the samples. As illustrated in FIG. 5 and the tables, with increased film coefficients, temperature differences within both samples increased. When the same film coefficients were applied to the samples, the high temperature support rack sample demonstrated lower minimum temperatures compared to the solid plate sample, which suggested the high temperature rack should have a higher cooling rate compared to the solid plate.

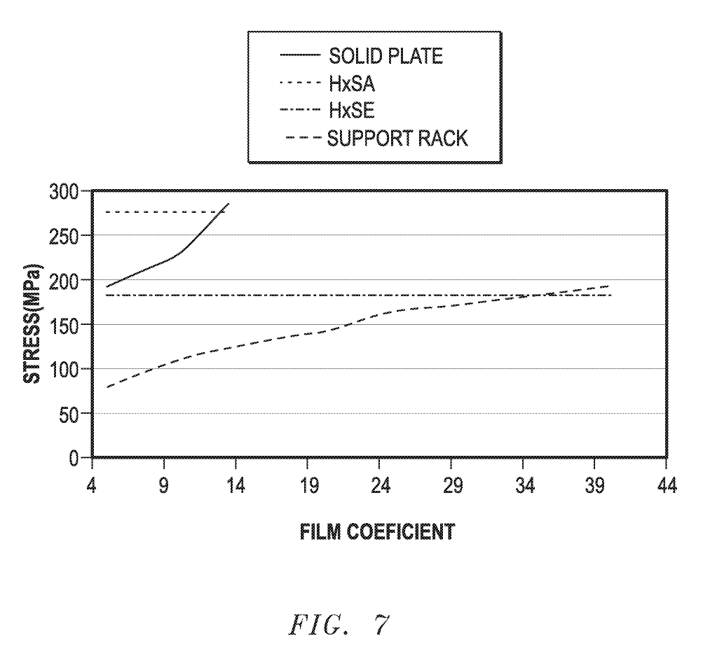

FIG. 6 includes a plot of thermal stress versus temperature differences of the samples. As illustrated, the high temperature support rack demonstrated higher temperature differences, but generated much smaller thermal stress within the sample compared to the solid plate. For instance, the solid plate sample had the thermal stress of 190.06 MPa with the temperature difference of 118.72° C., while the high temperature support rack sample had the thermal stress of 78.174 MPa with the temperature difference of 326.01° C. The vertical dotted lines illustrated in FIG. 6 represents maximum tensile strength of Hexoloy® SA and Hexoloy® SE, which are referred to as HxSA and HxSE, respectively.

FIG. 7 includes a plot of film coefficients versus thermal stress of the solid plate and high temperature support rack samples. The high temperature rack sample demonstrated lower thermal stress at each applied film coefficient, which corresponds to improved ability to withstand faster cooling rates, compared to the solid plate.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A support rack comprising:
a plurality of first ceramic rods comprising a ceramic material; and
a plurality of second ceramic rods comprising a ceramic material;
wherein the first ceramic rods intersect with the second ceramic rods and the first and second ceramic rods are coupled via a ceramic weld.

2. The support rack of claim 1, wherein at least one of the first ceramic rods comprises a sidewall defining an outer surface and an inner hollow center.

3. The support rack of claim 1, wherein at least one of the first ceramic rods has a cylindrical shape.

4. The support rack of claim 1, wherein at least one of the first ceramic rods has a width or diameter of at least 0.3 cm and at most 11 cm.

5. The support rack of claim 1, wherein a width or diameter of at least one of the second ceramic rods is greater than a width or diameter of at least one of the first ceramic rods.

6. The support rack of claim 1, wherein at least one of the first ceramic rods has a length of at least 40 cm and at most 150 cm.

7. The support rack of claim 1, wherein the ceramic material of at least one of the first ceramic rods or the second ceramic rods comprises silicon carbide.

8. The support rack of claim 1, wherein the ceramic material of at least one of the first ceramic rods is the same as the ceramic material of at least one of the second ceramic rods.

9. The support rack of claim 1, wherein the plurality of first ceramic rods is orthogonal to the plurality of second ceramic rods.

10. The support rack of claim 1, wherein the first and second ceramic rods intersect in a lattice configuration.

11. The support rack of claim 1, wherein the support rack has a length of at least 50 cm, a width of at least 40 cm, or both.

12. The support rack of claim 1, wherein the support rack has a total area of at least 2000 cm² and at most 12000 cm²

13. The support rack of claim 1, wherein the support rack comprises the first and second ceramic rods in a lattice configuration that defines a plurality of open windows at least one having an area of at least 2 cm² and at most 100 cm².

14. The support rack of claim 1, wherein the support rack comprises a surface flatness of at most 50 μm.

15. An article of kiln furniture comprising the support rack of claim 1.

16. A method of making a support rack comprising:
providing a plurality of first ceramic rods comprising a sintered ceramic material;
providing a plurality of second ceramic rods comprising a green ceramic material;
arranging the first and second ceramic rods so that the sintered first ceramic rods intersect with the green second ceramic rods; and
sinter bonding the first and second ceramic rods together to form a ceramic weld at the intersection.

17. The method of claim 16, wherein the green second ceramic rods each comprise at least one aperture corresponding to each of the first ceramic rods.

18. The method of claim 17, wherein arranging the first and second ceramic rods comprises arranging the plurality of green second ceramic rods to align the corresponding apertures and extending the first ceramic rods through the corresponding apertures of the green second ceramic rods so as to form a lattice structure.

19. The method of claim 17, wherein, during sintering, the apertures of the second ceramic rods shrink to surround an outer surface of a portion of each of the first ceramic rods.

20. The method of claim 19, wherein the ceramic material of the green second ceramic rods has a differential shrinkage sufficient to ensure bonding during the sinter bonding.
